(19) United States
(12) Patent Application Publication
(10) Pub. No.: US 2011/0307504 A1
(43) Pub. Date: Dec. 15, 2011

(54) COMBINING ATTRIBUTE REFINEMENTS AND TEXTUAL QUERIES

(75) Inventors: Rakesh Agrawal, San Jose, CA (US); John Christopher Shafer, Los Altos, CA (US); Fabian Martin Suchanek, Lippstadt (DE)

(73) Assignee: MICROSOFT CORPORATION, Redmond, WA (US)

(21) Appl. No.: 12/796,673

(22) Filed: Jun. 9, 2010

(51) Int. Cl. G06F 17/30

(52) U.S. Cl. 707/766; 707/E17.074; 707/765

(57) ABSTRACT

A user submits an unstructured query that is analyzed to determine a mapping from attributes to attribute values. One or more matching items from a structured data set are determined based on the attribute values of attributes associated with the items. The matching items are displayed. One or more refinement attributes are displayed, each with one or more attribute values. The attribute values in the refinements that correspond to the attribute values of the query are shown as selected. If the user selects any of the refinement attributes, the query is revised to incorporate the attribute values of the selected refinements. New matching items are determined using the revised structured query. The revised structured query and the new matching items are displayed. This process can be iterated, by modification of the query or the refinements. The matching items, the selected refinement attribute values and the query are synchronized.

### BACKGROUND

Structured data sources typically include structured data tuples of attributes stored in a database. Each attribute may have one of several attribute values. Examples of structured data sources include product databases, movie schedule databases, and airline flight databases. Because structured data sources have well defined attributes (schema), they are typically queried using methods that take advantage of the underlying schema such as a query language like SQL or using a form in a webpage. For example, a user may search flights at a travel website by entering a date in a form box corresponding to a date, a city into a form box corresponding to a destination, and a city into a form box corresponding to an origination. Because the form of the travel website enforces the schema of the underlying structured data, the structured data can be easily searched by matching the entered attribute values with attribute values of their corresponding attribute in the structured data.

As the power of search engines has grown, users have become more comfortable making free form text based queries by typing one or more terms into a single box at a search engine. These types of searches typically result in the search engine returning webpages having text that matches one or more of the terms of the query. While this method is useful for searching text based webpages, it is less useful for searching for items stored as structured data such as consumer products. For example, when a user is shopping for a product they may enter a free form text query corresponding to the product that they are looking for such as “Samsung 42 inch television”. Because determining a structured query from the terms of a free form query is difficult, the terms of the query may be searched against keywords from webpages corresponding to the products rather than the structured data. However, searching using keywords may be over inclusive because it matches any products that include the keywords and not just the products that the user was looking for. For example, the query described above may match Samsung televisions as well as associated products such as stands and mounts designed to work with the televisions even though the user was only looking for televisions.

The over inclusiveness of the products returned using keyword searches may be particularly problematic in webpages that allow users to refine their search using refinements. Typically refinements are based on attribute values of structured data and are displayed next to matching products. However, because the initial set of matching products is based on terms of a free form query and is over inclusive, the refinements displayed may be limited to broad categories associated with the matching products rather than the product that the user was looking for. Further, if the user selects one of the displayed refinements, the terms of the free form query are typically abandoned for the selected refinements, rather than being used to update or modify the terms of the free form query or the matching products. This may lead to a lack of synchronization between the terms of the query submitted by the user, the displayed refinements, and the matching products. Such lack of synchronization may lead to user dissatisfaction or confusion causing the user to leave their search session.

### SUMMARY

A structured query that includes attribute values for one or more attributes is received from a user and used to determine one or more matching items from a structured data set based on attribute values of attributes associated with the items. The matching items are displayed to the user who submitted the original query along with the structured query. In addition, one or more refinements are displayed to the user. If the user selects any of the one or more refinements, the structured query is revised to incorporate the attribute values of the selected one or more refinements and one or more new matching items are determined using the revised structured query. The revised structured query and the new matching items are displayed to the user. In this way, the attribute and attribute values of the displayed and/or selected refinements and the attributes and attribute values of the structured query are synchronized. Such synchronization is an improvement over existing systems where a displayed query and selected refinements are not synchronized, leading to user confusion and/or dissatisfaction.

In an implementation, a query is received by a computing device, e.g. through a network. The query includes one or more terms. A first structured query is determined based on the terms of the received query by the computing device. The first structured query includes one or more attributes values and each attribute value is associated with an attribute. A first plurality of items that match the first structured query is determined by the computing device. Each item is associated with one or more attribute values and each attribute value is associated with an attribute. A first plurality of refinements is provided for display by the computing device. The first plurality of refinements is based on the attribute values associated with the attributes of the first structured query. A first plurality of indicators is provided for display by the computing device. Each of the indicators indicates one of the first plurality of items.

Implementations may include some or all of the following features. The first structured query may be provided for display. An indication of a selection of one or more of the first plurality of refinements may be received. A second structured query may be determined based on the first structured query and on the selected refinements of the first plurality of refinements. The second structured query may include one or more attribute values and each attribute value is associated with an attribute. A second plurality of items that match the second structured query may be determined. A second plurality of indicators may be provided for display. Each of the second plurality of indicators may indicate one of the second plurality of items. The second structured query may be provided for display. A second plurality of refinements may be provided for display. The second plurality of refinements may be based on the attribute values associated with the attributes of the second structured query. The indicators may comprise uniform resource locators (URLs). The items may be consumer products. The items may comprise information from an application domain where data is in structured form comprising at least one of books, consumer electronics, restaurant listings, airplane schedules, or consumer products. At least one refinement of the first plurality of refinements may be a preselected refinement.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an example environment for refining structured queries;

FIG. 2 is an illustration of an example user interface for providing a query;

FIG. 3 is an illustration of an example user interface for displaying one or more items received in response to a query and for displaying query refinements;

FIG. 4 is another illustration of an example user interface for displaying one or more items received in response to a query and for displaying query refinements;

FIG. 5 is another illustration of an example user interface for displaying one or more items received in response to a query and for displaying query refinements;

FIG. 6 is an operational flow of an implementation of a method for providing indicators of items in response to a structured query and updating the indicated items in response to a selection of one or more refinements;

FIG. 7 is an operational flow of an implementation of another method for providing indicators of items in response to a structured query and updating the indicated items in response to a selection of one or more refinements; and

FIG. 8 is a block diagram of an example computing system environment according to an implementation of the present system.

### DETAILED DESCRIPTION

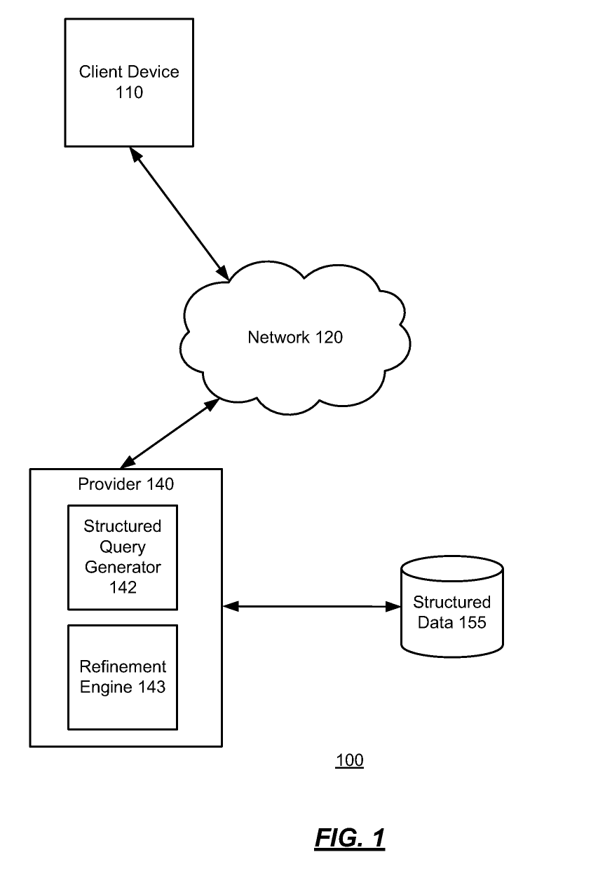

FIG. 1 is an illustration of an example environment 100 for refining structured queries. A client device 110 may communicate with a provider 140 through a network 120. The client device 110 may be configured to communicate with the provider 140 to access, receive, retrieve, and display content and other information such as webpages. The network 120 may be a variety of network types including the public switched telephone network (PSTN), a cellular telephone network, and a packet switched network (e.g., the Internet). Although only one provider 140 is shown in FIG. 1, it is contemplated that the client device 110 may be configured to communicate with one or more providers 140 through the network 120.

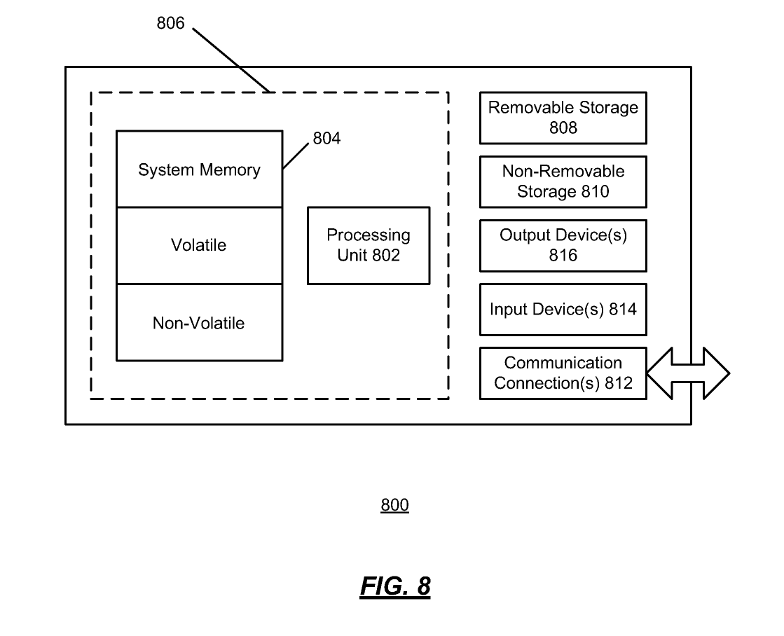

In some implementations, the client device 110 may include a computing device, such as a desktop personal computer, workstation, laptop, personal digital assistant (PDA), cell phone, or any WAP-enabled device or any other computing device capable of interfacing directly or indirectly with the network 120. The client device 110 may be implemented using one or more computing devices such as the computing system 800 described with respect to FIG. 8. The client device 110 may run an HTTP client, e.g., a browsing program, such as MICROSOFT INTERNET EXPLORER or other browser, or a WAP-enabled browser in the case of a cell phone, PDA, or other wireless device, or the like, allowing a user of the client device 110 to access, process, and view information and pages available to it from the provider 140.

In some implementations, the provider 140 may receive queries and may provide indicators of one or more items that are responsive to the query. The items may be a variety of products and/or services and may include books, consumer electronics, restaurant listings, and airplane schedules, for example. The provider 140 may be a search engine or may be a merchant or other provider. The provider 140 may be implemented using one or more computing devices such as the computing system 800 described with respect to FIG. 8.

The provider 140 may have access to structured data 155. The structured data 155 may include one or more structured data tuples organized into one or more sets or tables corresponding to a variety of categories. Each structured data tuple may correspond to an item, and may include one or more attributes corresponding to features of the item that the structured data tuple purports to represent. Each attribute may have one or more attribute values. The structured data 155 may be implemented as a database and/or a collection of tables, or as XML data, for example. Any one or more of a variety of known data structures may be used for the structured data 155.

For example, the provider 140 may be an online retailer and may maintain their inventory as structured data 155. A schema specific to the structured data 155 may be used to generate webpages, catalogs, reports, etc., based on the structured data 155 because of the well defined attributes of the structured data tuples in the structured data 155. Examples of businesses or merchants that may use structured data 155 may include travel websites, movie websites, and libraries.

In some implementations, the provider 140 may receive structured queries and may provide identifiers of one or more items in response to the structured queries. A structured query may be a query that uses the schema of the structured data 155 and may specify one or more attributes and one or more attribute values. For example, a structured query for green shoes may be “{category:shoes, color=: green}”. The specified attributes are “category” and “color”, and the corresponding attribute values are “shoes” and “green”. The provider 140 may then determine items matching the attribute and attribute value combinations defined by the structured query and return identifiers of the matching items. In some implementations, the identifiers may be uniform resource locators (URLs).

Because users typically do not know or are not aware of the schema used by the provider 140, a user of a client device 110 may provide their structured query using a form or other user interface element that enforces the schema of the structured data 155. Continuing the example described above, the user may use a browser to access a webpage associated with the provider 140. The webpage may include a form that has a drop down box for one or more attributes of the structured data 155. The user may select “shoes” from a drop down box of available categories, and may select “green” from a drop down box of available colors. The user may then submit the form and a corresponding structured query may be generated based on the user selections.

However, because of the popularity of search engines, users have become accustomed to providing free form queries rather than using structured queries. A free form query includes a plurality of terms. For example, a user looking to purchase a 42 inch Samsung television would simply enter the query “42 inch Samsung Television” rather than a structured query such as “{Category:Television, Brand:Samsung, Size:42 inch}”.

To facilitate searches on structured data 155 using terms of a query, the provider 140 may further include a structured query generator 142. The structured query generator 142 may generate one or more possible structured queries from the terms of a received query. In some implementations, the structured query generator 142 may generate a structured query by mapping the terms of the query to attribute values of attributes of a table of the structured data 155. Other methods for generating a structured query may be used. An example system for generating structured queries from query terms is described in U.S. patent application Ser. No. 12/694,294, filed on Jan. 27, 2010 and entitled “ANNOTATING QUERIES OVER STRUCTURED DATA”, and which is incorporated by reference herein in its entirety.

In some implementations, when generating a structured query from the terms of the query, some of the terms of the query may not map to any attribute values of attributes of the structured data 155. Rather than discard these non-matching terms, the non-matching terms may be retained and used to rank items or products that match the generated structured query, for example.

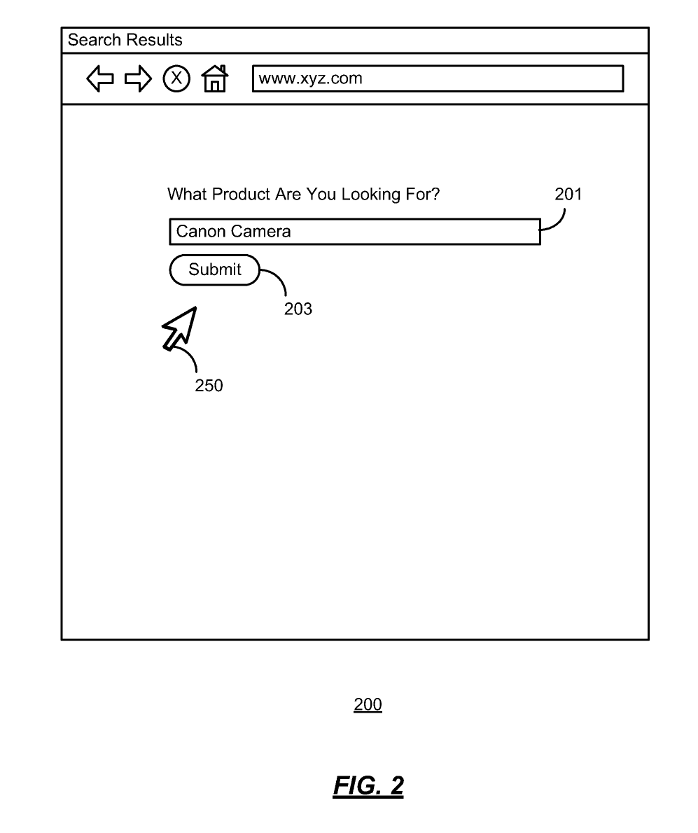

In some implementations, the provider 140 may receive a query from a client device 110 and provide it to the structured query generator 142 to generate a structured query from the terms of the query. The query may be received from the client device 110 through a user interface implemented using a webpage, for example. An example of such a user interface is illustrated in the user interface 200 of FIG. 2.

As shown in FIG. 2, a user has entered a query that includes the terms “Canon” and “Camera” into a search box user interface element 201. In the example, the user may submit the query to the provider 140 by selecting a user interface element 203 labeled “submit” using a pointer 250.

The provider 140 may receive the user submitted query and provide it to the structured query generator 142. The structured query generator 142 may determine a structured query based on the terms of the received query. Continuing the example described above, the structured query generator 142 may determine that the structured query corresponding to the received query is “{Brand:Canon, Product:Camera}”.

The provider 140 may use the structured query to determine one or more items that match the structured query. The provider 140 may then provide indicators of the determined one or more items in a user interface. In some implementations, the identifiers may be URLs, for example.

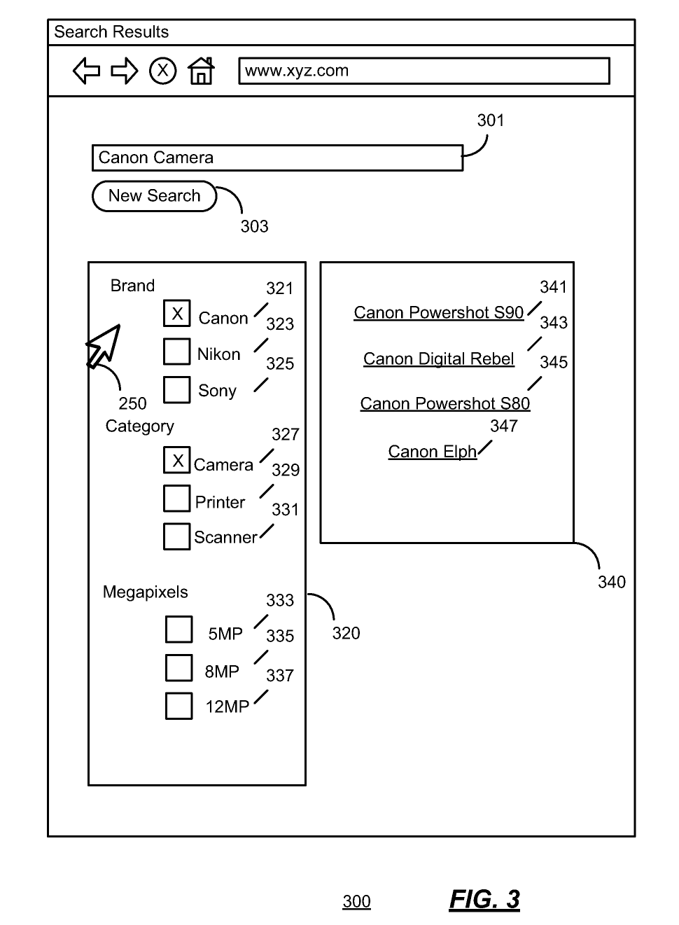

Continuing the example described above, FIG. 3 shows an example user interface 300 generated by the provider 140 using a structured query corresponding to the query entered by the user in the user interface element 201. The user interface 300 includes a results window 340 where indicators of items that are responsive to the structured query are displayed. The structured query used to determine the indicated items is displayed in a user interface element 301 as “Canon Camera”. As illustrated, the structured query is displayed as a free-form query without the schema used by the structured data 155 including attribute names and attribute values. Alternatively, the structured query can be displayed using the schema used by the structured data 155. As shown, the user may refine or change the terms of the query in the user interface element 301 and submit the new query by selecting the user interface element 303 labeled “New Search” using the pointer 250.

As illustrated, the results window 340 includes a plurality of indicators or links to items that match or are otherwise responsive to the structured query. In an implementation, an item matches a structured query when the attribute and attribute values corresponding to the item match the attribute and attribute values of the structured query. As shown, the indicators include links 341, 343, 345, and 347. More or fewer viewer indicators may be displayed. In addition, in some implementations, the indicators may be displayed with images or videos associated with the matching items as well as text or other content taken from a webpage or other storage associated with the items.

The provider 140 may further include a refinement engine 143. The refinement engine 143 may provide one or more refinements for display based on attributes and attribute values of the items that match the structured query. As illustrated in FIG. 3, the refinements may be displayed to the user in a refinements window 320. The refinements window 320 displays the one or more refinements that the user may select to refine the structured query displayed in the user interface element 301. The refinements displayed in the refinements window 320 include refinements 321, 323, 325, 327, 329, 331, 333, 335, and 337. More or fewer refinements may be displayed.

In this example, the refinements 321, 323 and 325 correspond to the attribute values “Canon”, “Nikon”, and “Sony” which are attribute values of the attribute “Brand”. The refinements 327, 329, and 331 correspond to the attribute values “Camera”, “Printer”, and “Scanner” of the attribute “Category”. The refinements 333, 335, and 337 correspond to the attribute values “5 MP”, “8 MP”, and “12 MP” of the attribute “Megapixels”.

As illustrated, each of the refinements in the refinements window 320 is displayed with a selection box adjacent to it. The refinement engine 143 of the provider 140 has preselected the boxes adjacent to the refinement 321 and the refinement 327 by placing an “x” in the box because the attribute values corresponding to the refinements 321 and 327 are part of the structured query displayed in the user interface element 301.

The user may select or deselect the refinements in refinements window 320 using the pointer 250. In some implementations, in response to the user selecting or deselecting a refinement, the refinement engine 143 may update the structured query displayed in the user interface element 301 and determine new items that match the updated structured query. Indicators of the new items may then be displayed to the user in the results window 340.

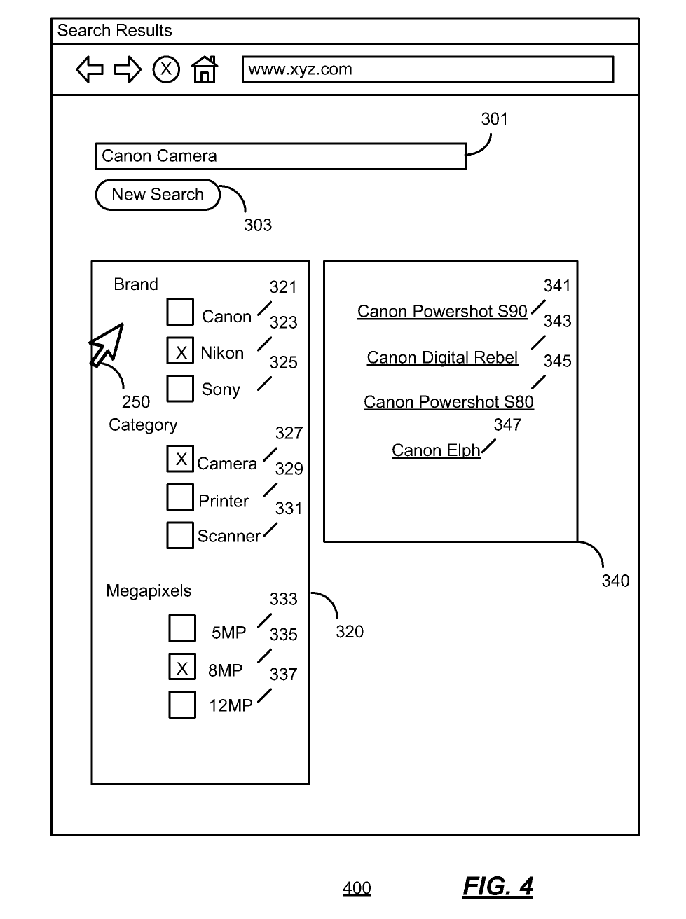

For example, as illustrated in an example user interface 400 of FIG. 4, the user has deselected the refinement 321 corresponding to the attribute value “Canon” of the attribute “Brand” and selected the refinement 323 corresponding to the attribute value “Nikon” of the attribute “Brand”. In addition, the user has selected the refinement 335 corresponding to the attribute value “8 MP” corresponding to the attribute “Megapixels”.

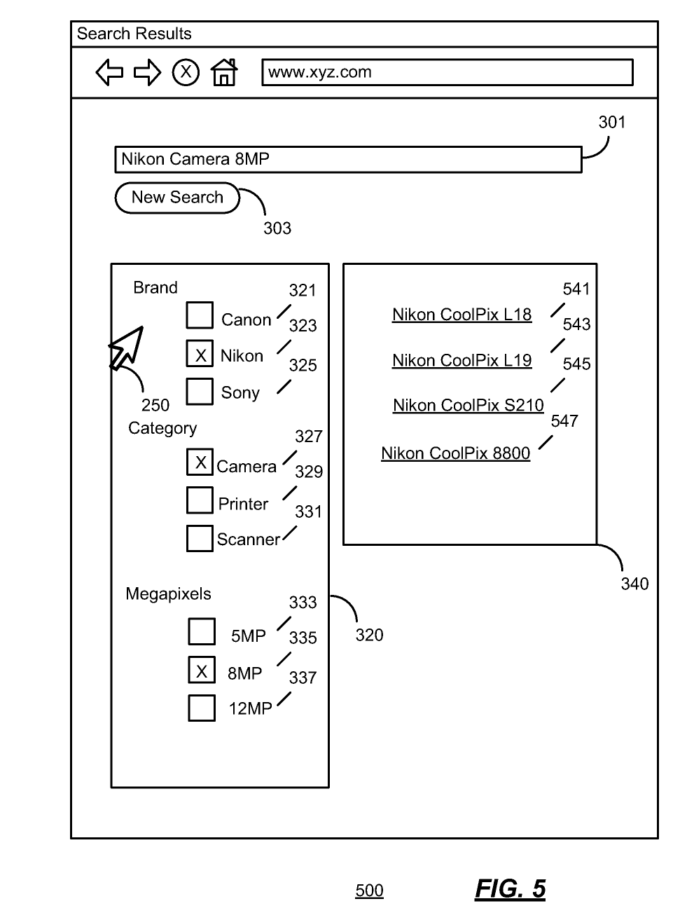

Accordingly, as illustrated in an example user interface 500 of FIG. 5, in response to the user selections and/or deselections, the refinement engine 143 of the provider 140 has updated the user interface element 301 with a new structured query based on the selected refinements. The user interface element 301 now includes the free-form version of the structured query “Nikon Camera 8 MP” corresponding to the selected refinements 321, 323, and 335.

In addition, the refinement engine 143 of the provider 140 has determined new items that match the updated structured query and has updated the results window 340 accordingly. As illustrated, the results window 340 now includes links 541, 543, 545, 547 corresponding to items that match the structured query displayed in the user interface element 301.

In some implementations, the refinement engine 143 of the provider 140 may further provide a new set of refinements for display in the refinements window 320. As described above, the refinements in the refinements window 320 may be based on the attribute and attribute values of the items indicated in the results window 340. Accordingly, a new set of refinements may also be provided for display based on the attributes and attribute values of the new items. The attribute values that match the attribute values of the new structured query may be preselected as described above.

The refinement engine 143 of the provider 140 may continue to synchronize the refinements displayed in the refinements window 320, the results displayed in the results window 340, and the query displayed in the user interface element 301. For example, any changes made to the attribute values and/or attributes of the query in the user interface element 301 will be carried over to the refinements displayed in the refinements window 320 and the results displayed in the results window 340 by the refinement engine 140. Similarly, any changes made to the refinements in the refinements window 320 (e.g., selecting or unselecting one or more refinements) will be carried over to the query in the user interface element 301 and the results displayed in the results window 340. In this way, the provider 140 maintains synchronicity between the structured query, the refinements, and displayed results, creating a greater search experience for the user. This is contrast with prior art systems where the initial query submitted by the user would remain in the user interface element 301 even after the user had selected one or more refinements from the refinements window 320, creating a disconnect between the displayed query and the results displayed in the results window 340.

As illustrated in the previous example, in some implementations, the new structured query may be generated simply by adding or modifying the attribute corresponding to the attribute value for each selected refinement. However, where the user selects multiple refinements for a displayed attribute, additional care may be taken when constructing the structured query. For example, if the user were to select both the refinement corresponding to the Nikon brand and the Canon brand, a structured query that requires the brand to be both Nikon and Canon will not match any products because a product can have only one brand. Thus, where an attribute is exclusive and can only have one value per product, when multiple refinements corresponding to the attribute are selected, a separate structured query may be generated for each exclusive attribute. For example, refinement engine 143 may maintain a list of such exclusive attributes.

In contrast, where attributes are not exclusive, the structured query may be modified for the selected refinements by adding to the existing structured query. For example, for an attribute such as “Features” that can take on multiple attribute values for a single product (e.g., “Flash”, “Waterproof”, and “Replaceable Lenses”), an attribute and attribute value pair can be added to the existing structured query corresponding to each refinement selected by the user.

In some implementations, where one or more terms of the submitted query cannot be mapped to attribute values of attributes of the structured data 155, the non-matching terms may be displayed to the user in the user interface element 301 even though the non-matching terms are not part of the generated structured query. In addition, as the user selects one or more refinements from the refinements window 320, the non-matching terms may continue to be displayed in the user interface element 301 after the refinements and query are synchronized.

For example, if a user submits the free-form query “$10 Harry Potter DVDs” in the user interface element 301, the structured query generator 142 may only identify {Price:$10, Category:DVD} as the structured query and the term “Harry Potter” may be unmatched. Nevertheless, the free-form text query “$10 Harry Potter DVD” may be displayed in the user interface element 301. If the user then selects a refinement from the refinements window 320 such as “NTSC”, the structured query may become {Price:$10, Category:DVD, Format:NTSC} and the displayed free-form query in the user interface element 301 may be synchronized to become “$10 Harry Potter DVDs NTSC”. Note that the unmatched term “Harry Potter” remains in the user interface element 301 even though it is not strictly part of the updated structured query.

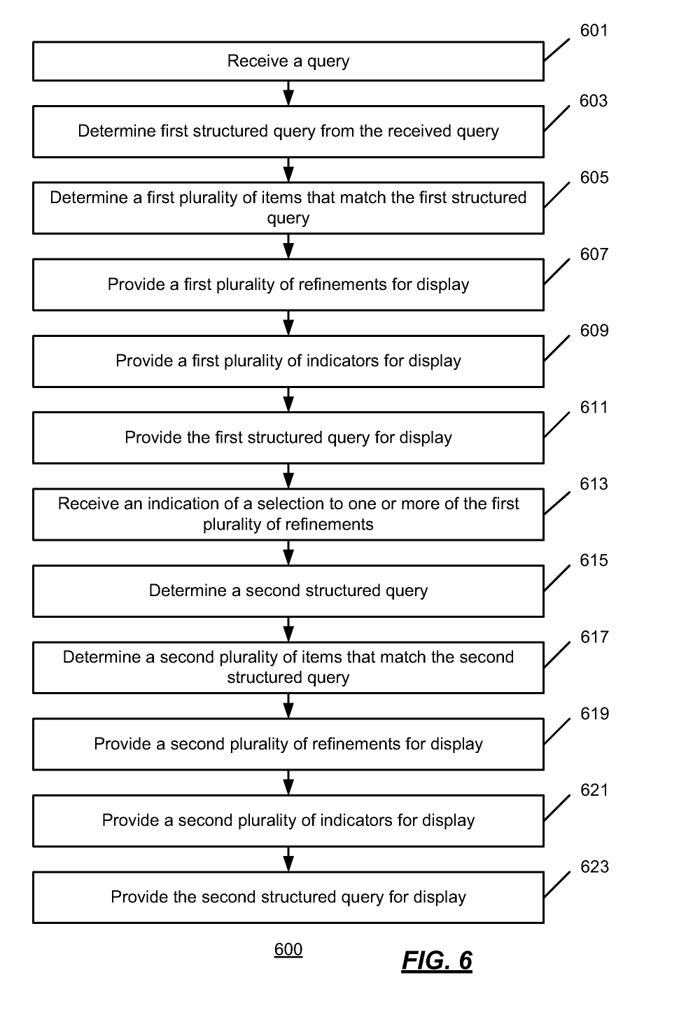

FIG. 6 is an operational flow of an implementation of a method 600 for providing indicators of items in response to a structured query and updating the indicated items in response to one or more refinement selections. The method 600 may be implemented by the provider 140, for example.

A query is received at 601. In some implementations, the query may be received by the structured query generator 142 of the provider 140 from a user at a client device 110. The query may be a free form query and may comprise one or more terms. In order to fulfill the received query from structured data 155, a structured query may be determined from the terms of the received query.

A first structured query is determined from the received query at 603. The first structured query may be determined from the received query by the structured query generator 142 of the provider 140. The structured query may include one or more attribute values and each attribute value may be associated with an attribute. In some implementations, the first structured query may be determined using the systems and methods described in U.S. patent application Ser. No. 12/694,294, filed on Jan. 27, 2010 and entitled “ANNOTATING QUERIES OVER STRUCTURED DATA”, and which is incorporated by reference herein in its entirety.

A first plurality of items that match the first structured query is determined at 605. The first plurality of items may be determined by the provider 140 from the structured data 155 using the generated first structured query. For example, the provider 140 may determine items that have associated attributes and corresponding attribute values that match one or more of the attributes and corresponding attribute values of the first structured query. In some implementations, the items may be products available for purchase such as consumer electronics, household goods, clothes, shoes, etc.

A first plurality of refinements is provided for display at 607. The first plurality of refinements may be provided by the refinement engine 143 of the provider 140 for display to the user of the client device 110. The first plurality of refinements may correspond to attribute values of the determined first plurality of items. The first plurality of refinements may be provided to the user for display in a web browser executing on the client device 110 in a refinements window 320. In some implementations, the refinements corresponding to attribute values of the structured query may be “preselected” by displaying a graphic or other indicator adjacent to the refinements.

A first plurality of indicators is provided for display at 609. The first plurality of indicators may be provided by the provider 140 for display to the user of the client device 110. Each of the indicators in the first plurality of indicators may correspond to an item from the first plurality of items. In some implementations, the indicators are links such as URLs and may be provided for display in a results window 340 by the web browser executing on the client device 110.

The first structured query is provided for display at 611. The first structured query may be provided by the provider 140 for display to the user of the client device 110. In some implementations, the first structured query may be provided for display in a user interface element 301 by the web browser executing on the client device 110.

An indication of a selection to one or more of the first plurality of refinements is received at 613. The indication of a selection may be received by the refinement engine 143 of the provider 140 from the user of the client device 110. In some implementations, the user may have selected one or more of the first plurality of refinements displayed in the refinements window 320 using a pointer 250.

A second structured query is determined at 615. The second structured query may be determined by the refinement engine 143 of the provider 140 based on the selected one or more refinements. For example, as described previously, the refinements may correspond to attribute values. Thus, the second structured query may be determined based on the attribute values corresponding to the one or more refinements.

A second plurality of items that match the second structured query is determined at 617. The second plurality of items that match the second structured query may be determined by the provider 140. For example, the provider 140 may determine items that have associated attributes and corresponding attribute values that match one or more of the attributes and corresponding attribute values of the second structured query.

A second plurality of refinements is provided for display at 619. The second plurality of refinements may be provided by the refinement engine 143 of the provider 140 for display to the user of the device 110. The second plurality of refinements may correspond to one or more attribute values of the determined second plurality of items. The second plurality of refinements may be displayed to the user in the refinements window 320.

A second plurality of indicators is provided for display at 621. The second plurality of indicators may be provided by the provider 140 for display to the user of the client device 110. Each of the indicators corresponds to an item from the second plurality of items. In some implementations, the indicators may be provided for display in the results window 340 by the web browser executing on the client device 110.

The second structured query is provided for display at 623. The second structured query may be provided for display by the provider 140. In some implementations, the second structured query may be provided for display in the user interface element 301 by the web browser executing on the client device 110.

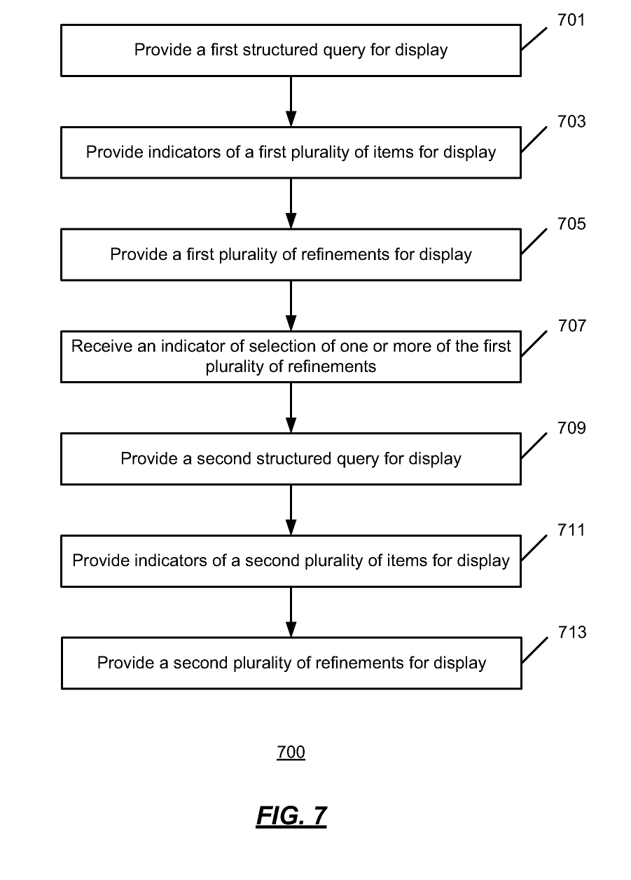

FIG. 7 is an operational flow of an implementation of a method 700 for providing indicators of item in response to a structured query and updating the indicated items in response to a selection of one or more refinements. The method 700 may be implemented by the provider 140, for example.

A first structured query is provided for display at 701. The first structured query may be provided for display by the provider 140 in a web browser of a computing device or system such as the client device 110. The first structured query may be displayed in a user interface element 301. In some implementations, the first structured query may have been generated by the structured query generator 142 from the terms of a query received from a user of the client device 110. Alternatively, the first structured query may have been generated by the user using a form or other entry method that enforces the underlying schema of the structured data 155, for example.

Indicators of a first plurality of items are provided for display at 703. The indicators of a first plurality of items may be provided by the provider 140 for display in the web browser of the client device 110. For example, the indicators of the first plurality of items may be provided for display in a results window 340. In some implementations, the indicators may be links to items from the structured data 155 that were determined to match the first structured query.

A first plurality of refinements is provided for display at 705. The first plurality of refinements may be provided by the provider 140 for display in the web browser of the client device 110. For example, the first plurality of refinements may be provided for display in a refinements window 320. Each of the first plurality of refinements may correspond to an attribute value associated with one of the first plurality of items. In some implementations, the refinements that correspond to attribute values of the first structured query may be “preselected” and displayed with a check or other indicator or graphic, for example.

An indicator of selection of one or more of the first plurality of refinements is received at 707. The indicator of a selection may be received by the refinement engine 143 of the provider 140 from the client device 110. For example, a user of the client device 110 may have selected one or more of the refinements displayed in the refinements window 320 using a pointer 250.

A second structured query is provided for display at 709. The second structured query may be provided for display by the refinement engine 143 of the provider 140 for display in the web browser of the client 110. The second structured query may have been determined by the refinement engine 143 based on the first structured query and the selected refinements. The second structured query may be displayed in the user interface element 301 in place of the first structured query. Thus, the structured query displayed in the user interface element 301 is updated to reflect the attribute values corresponding to the one or more selected refinements.

Indicators of a second plurality of items are provided for display at 711. The indicators of a second plurality of items may be provided by the provider 140 for display in the web browser of the client device 110. For example, the indicators of the second plurality of items may replace the indicators of the first plurality of items in the results window 340. Similarly to the first plurality of items, the indicators of the second plurality of items may be links to items from the structured data 155 that were determined to match the second structured query.

A second plurality of refinements is provided for display at 713. The second plurality of refinements may be provided by the provider 140 for display in the web browser of the client device 110. For example, the second plurality of refinements may replace the first plurality of refinements in the refinements window 320.

FIG. 8 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers (PCs), server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 8, an exemplary system for implementing aspects described herein includes a computing device, such as computing system 800. In its most basic configuration, computing system 800 typically includes at least one processing unit 802 and memory 804. Depending on the exact configuration and type of computing device, memory 804 may be volatile (such as random access memory (RAM)), non-volatile (such as read-only memory (ROM), flash memory, etc.), or some combination of the two. This most basic configuration is illustrated in FIG. 8 by dashed line 806.

Computing system 800 may have additional features/functionality. For example, computing system 800 may include additional storage (removable and/or non-removable) including, but not limited to, magnetic or optical disks or tape. Such additional storage is illustrated in FIG. 8 by removable storage 808 and non-removable storage 810.

Computing system 800 typically includes a variety of computer readable media. Computer readable media can be any available media that can be accessed by device 800 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 804, removable storage 808, and non-removable storage 810 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing system 800. Any such computer storage media may be part of computing system 800.

Computing system 800 may contain communications connection(s) 812 that allow the device to communicate with other devices. Computing system 800 may also have input device(s) 814 such as a keyboard, mouse, pen, voice input device, touch input device, etc. Output device(s) 816 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method comprising:
receiving a query by a computing device through a network, wherein the query comprises one or more terms;
determining a first structured query based on the terms of the received query by the computing device, wherein the first structured query comprises one or more attributes values and each attribute value is associated with an attribute;
determining a first plurality of items that match the first structured query by the computing device, wherein each item is associated with one or more attribute values and each attribute value is associated with an attribute;
providing a first plurality of refinements for display by the computing device through the network, wherein the first plurality of refinements are based on the attribute values associated with the attributes of the first structured query; and
providing a first plurality of indicators for display by the computing device through the network, wherein each indicator of the first plurality of indicators indicates one of the first plurality of items.

2. The method of claim 1, further comprising providing the first structured query for display.

3. The method of claim 2, further comprising:
receiving an indication of selection of one or more of the first plurality of refinements;
determining a second structured query based on the first structured query and the selected one or more refinements, wherein the second structured query comprises one or more attributes values and each attribute value is associated with an attribute;
determining a second plurality of items that match the second structured query; and
providing a second plurality of indicators for display, wherein each indicator of the second plurality of indicators indicates one of the second plurality of items.

4. The method of claim 3, further comprising providing the second structured query for display.

5. The method of claim 4, wherein providing the second structured query for display comprises providing the second structured query for display as a free-form text query.

6. The method of claim 3, further comprising providing a second plurality of refinements for display, wherein the second plurality of refinements are based on the attribute values associated with the attributes of the second structured query.

7. The method of claim 1, wherein the indicators comprise uniform resource locators (URLs).

8. The method of claim 1, wherein the items comprise consumer products.

9. The method of claim 1, wherein the items comprise information from an application domain where data is in structured form comprising at least one of books, consumer electronics, restaurant listings, or airplane schedules.

10. A method comprising:
providing a first structured query for display by a computing device, wherein the first structured query comprises one or more attributes values and each attribute value is associated with an attribute;
providing indicators of a first plurality of items for display by the computing device, wherein each of the first plurality of items is associated with one or more attribute values that match the one or more attribute values associated with the attributes of the first structured query; and
providing a first plurality of refinements for display by the computing device, wherein the first plurality of refinements are based on at least the one or more attribute values associated with the attributes of the first structured query.

11. The method of claim 10, further comprising:
receiving an indication of selection of one or more of the first plurality of refinements;
providing a second structured query for display, wherein the second structured query is based on the first structured query and the selected one or more refinements of the first plurality of refinements; and
providing indicators of a second plurality of items for display, wherein the second plurality of items match the second structured query.

12. The method of claim 11, further comprising providing a second plurality of refinements for display.

13. The method of claim 11, further comprising receiving the first structured query through a webpage form.

14. The method of claim 11, further comprising:
receiving a query, wherein the query comprises a plurality of terms; and
generating the first structured query from the terms of the received query.

15. The method of claim 11, wherein the items comprise information from an application domain where data is in structured form comprising at least one of books, consumer electronics, restaurant listings, airplane schedules, or consumer products.

16. A system comprising:
at least one computing device; and
a provider that:
receives a query, wherein the query comprises one or more terms;
determines a first structured query based on the terms of the received query, wherein the first structured query comprises one or more attributes values and each attribute value is associated with an attribute;
determines a first plurality of items that match the first structured query, wherein each item is associated with one or more attribute values and each attribute value is associated with an attribute;
provides a first plurality of refinements for display, wherein the first plurality of refinements are based on the attribute values associated with the attributes of the first structured query; and
provides a first plurality of indicators for display, wherein each indicator of the first plurality of indicators indicates one of the first plurality of items.

17. The system of claim 16, wherein the provider further provides the first structured query for display.

18. The system of claim 16, wherein the provider further:
receives an indication of selection to one or more of the first plurality of refinements;
determines a second structured query based on the first structured query and the selected one or more refinements of the first plurality of refinements, wherein the second structured query comprises one or more attributes values and each attribute value is associated with an attribute;
determines a second plurality of items that match the second structured query; and
provides a second plurality of indicators for display, wherein each of the second plurality of indicators indicates one of the second plurality of items.

19. The system of claim 18, wherein the provider further provides the second structured query for display.

20. The system of claim 16, wherein the query is received through a webpage form.
